(19) United States
(12) Patent Application Publication
(10) Pub. No.: US 2004/0121651 A1
(43) Pub. Date: Jun. 24, 2004

(54) ELECTRICAL CONNECTOR WITH TERMINAL RETENTION MECHANISM

(76) Inventor: Zhi-Kai Guo, Kunsan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/418,891

(22) Filed: Apr. 18, 2003

(30) Foreign Application Priority Data
Dec. 20, 2002 (TW) 91220821

(51) Int. Cl. H01R 13/648

(52) U.S. Cl. 439/607

(57) ABSTRACT

An electrical connector (1) includes a dielectric housing (10), a plurality of terminals (12) received in the housing, and a retention mechanism (2) attached to the housing. The housing forms a pair of first mating members (103) at opposite ends thereof. Each terminal has a bending portion (124). The retention mechanism has an elongate stopper body (20). The stopper body has cantilevers (22) at opposite sides thereof. The cantilevers each define a second mating member (220) respectively mating with a corresponding first mating member, so that the stopper body presses on the bending portions of the terminals. Thus the terminals are firmly retained in the housing. In addition, the cantilevers are easily rotated outwardly so that the retention mechanism is assembled on and disassembled from the housing conveniently and safely.

### BACKGROUND OF THE INVENTION

1. Field of the Invention

The present invention relates to an electrical connector, and more particularly to an electrical connector with a retention mechanism for retaining contacts of the connector in a housing of the connector.

2. Description of the Prior Art

A conventional electrical connector disclosed in U.S. Pat. No. 5,797,769 comprises a dielectric housing, and a plurality of contacts received in the housing. The housing defines a plurality of contact-passages therein. Each contact has a retention portion forming a plurality of barbs at opposite sides thereof. The barbs of the contact interfere with internal walls of the housing in the corresponding contact-passage so as to retain the contact in the housing. However, the barbs of the contacts abut and abrade the walls of the contact-passages during mating and un-mating. After mating and un-mating the electrical connector many times, the contacts engage only loosely in the corresponding contact-passages. Any contact is easily pressed to move backward, or even drop out the corresponding contact-passage, during mating. As a result, reliability of electrical transmission of the connector is reduced. U.S. Pat. Nos. 5,630,730, 5,591,050 and 5,194,019 have similar shortcomings.

FIG. 5 shows another electrical connector as disclosed in Taiwan Patent Issue No. 234584. The connector 6 comprises a dielectric housing 60, a plurality of contacts 62 received in the housing 60, and an elongate retention plate 8. The contacts 62 are secured firmly in corresponding contact-passages 600 defined in the housing 60 by a retention plate 8 pressing base portions 620 of the contacts 62. Thus reliability of electrical transmission of the connector 6 is enhanced. During assembly of the retention plate 8 on the connector 6, protrusion portions 80 of the retention plate 8 are guided into corresponding grooves 64 of the housing 6. A positioning block 82 of the retention plate 8 slides over a slant surface 680 of a cutout 68 defined in the housing 6, and is then received in an opening 66 defined in the housing 60 below the cutout 68. A bottom edge wall 61 of the housing 6 supports the retention plate 8. Thus the retention plate 8 is firmly assembled on the housing 60.

However, with this structure, the retention plate 8 is removable from the housing 6 only with undue difficulty. Moreover, the retention plate 8 deforms along a widthwise direction thereof while the positioning block 82 slides over the slant surface 680 of the cutout 68. Great elastic force generated from the deformation is liable to damage the housing 6 and the retention plate 8. Thus assembly of the connector 6 is difficult and frequently results in wastage.

Accordingly, there is a need to provide an improved electrical connector with a retention mechanism that overcomes the above-mentioned problems.

### SUMMARY OF THE INVENTION

Accordingly, one main object of the present invention is to provide an electrical connector with an improved retention mechanism, wherein contacts of the electrical connector are firmly retained in a housing of the electrical connector, and the retention mechanism is assembled on and disassembled from the housing conveniently and safely.

To fulfill the above-mentioned object, an electrical connector with a retention mechanism is provided according to the present invention. The connector includes a dielectric housing, a plurality of terminals received in the housing, and a retention mechanism attached to the housing. The housing defines a plurality of terminal-passages therein, and forms first mating members at respective opposite ends thereof. Each terminal is received in the corresponding terminal-passage, and includes a bending portion outside the corresponding terminal-passage. The retention mechanism includes an elongate stopper body having cantilevers at respective opposite ends thereof. Each cantilever includes a second mating member at a distal end thereof. The first mating members respectively mate with the second mating members, in order to hold the retention mechanism on the housing. Simultaneously, the stopper body presses on the bending portions of the terminals in order to retain the terminals in the housing firmly.

In addition, the first mating members mate and un-mate with the second mating members by easily rotating the cantilevers outwardly. Thus the retention mechanism is assembled on and disassembled from the housing of the electrical connector conveniently and safely.

Other objects, advantages and novel features of the present invention will become more apparent from the following detailed description when taken in conjunction with the accompanying drawings, in which:

### BRIEF DESCRIPTION OF THE DRAWINGS

FIG. 1 is an exploded, isometric view of an electrical connector with a retention mechanism according to the present invention;

FIG. 2 is an isometric view of the retention mechanism of FIG. 1, but viewed from another aspect;

FIG. 3 is a partly cut-away view of the electrical connector of FIG. 1 fully assembled;

FIG. 4 is an enlarged view of a circled portion IV of FIG. 3; and

FIG. 5 is an exploded, isometric view of a conventional electrical connector.

### DESCRIPTION OF PREFERRED EMBODIMENT OF THE INVENTION

Reference will now be made to the drawings to describe the present invention in detail.

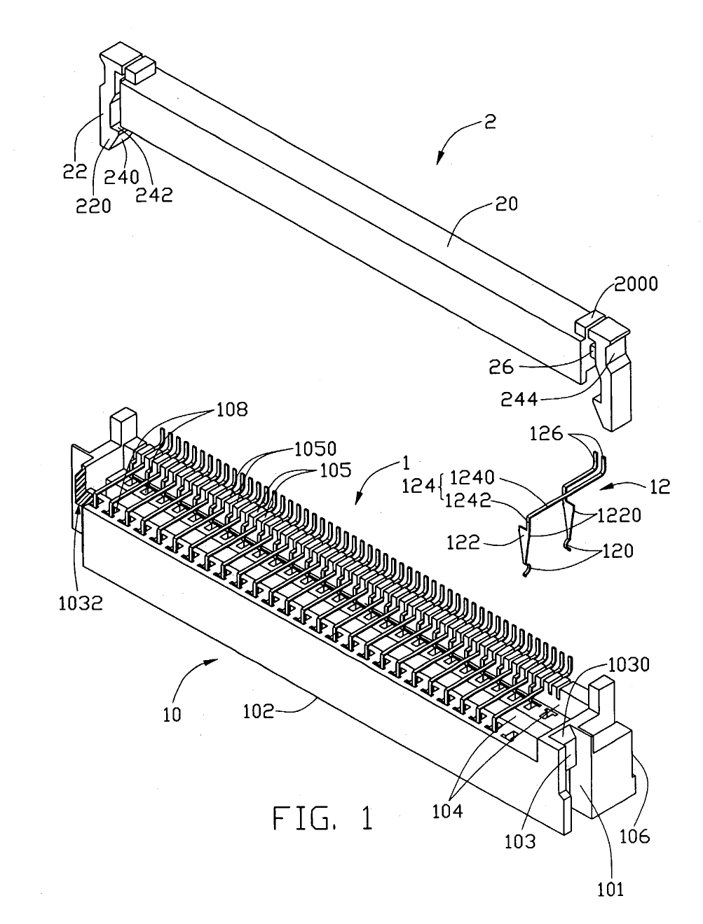

Referring now to FIG. 1, according to the present invention, there is shown an exploded isometric view of an electrical connector 1. The electrical connector 1 comprises an elongate dielectric housing 10, a plurality of electrical terminals 12 received in the housing 10, and a retention mechanism 2 attached to the housing 10. The housing 10 has a mating face 102, a rear face 104 opposite to the mating face 102, and a mounting face 106 for mounting the connector 1 onto a printed circuit board (not shown). The housing 10 defines top and bottom rows of terminal-passages 108 between the mating face 102 and the rear face 104.

The housing 10 also defines a pair of guiding grooves 101 at opposite lateral ends thereof respectively, the grooves 101 spanning between the mating face 102 and the rear face 104. An inner surface of the housing 10 at each groove 101 forms a first mating member 103. The first mating member 103 comprises a first slant surface 1030, and a first mating surface 1032 oriented at an acute angle relative to the inner surface of the housing 10 at the groove 101. The housing 10 further has a supporting wall 105 extending from the rear face 104 adjacent the mounting surface. The supporting wall 105 defines slots 1050 corresponding to the terminal-passages 108.

Each terminal 12 is received in a corresponding terminal-passage 108. The terminal 12 comprises a retention portion 122, a mating portion 120 at a bottom of the retention portion 122, and a bending portion 124 extending from one side of a top edge of the retention portion 122. The retention portion 122 forms a pair of barbs 1220 at opposite sides thereof respectively. The bending portion 124 comprises first and second extending portions 1240, 1242 that are perpendicular to each other, with the second extending portion 1242 extending coplanarly from the retention portion 122. The first extending portion 1240 bends perpendicularly from a top end of the second extending portion 1242. A soldering portion 126 is perpendicularly bent from a distal end of the first extending portion 1240, for soldering to the printed circuit board.

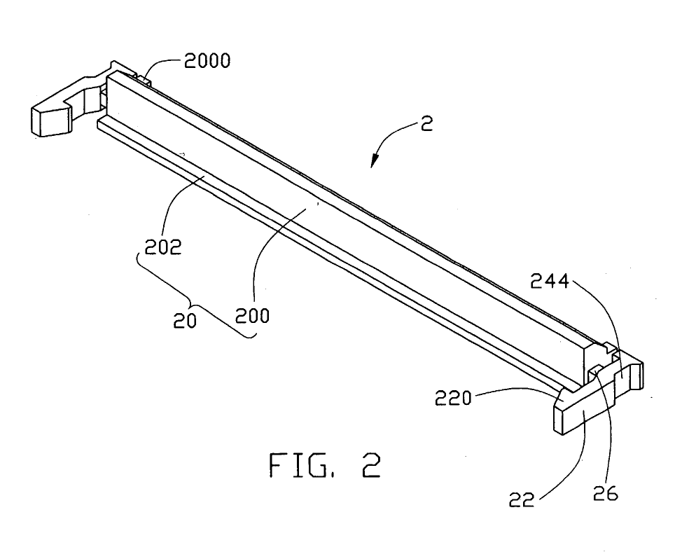

Referring to FIG. 2, the retention mechanism 2 is attached to the housing 10, and has an elongate stopper body 20. The stopper body 20 includes first and second elongate stopper walls 200, 202 that are perpendicular to each other. The first stopper wall 200 forms a pair of positioning portions 2000 at respective opposite ends of a top surface thereof. The first stopper wall 200 also forms a pair of cantilevers 22 pivotally attached to respective opposite ends of the first stopper wall 200 by a pair of connecting portions 26. Each connecting portion 26 has a relatively small cross-section, so that it is easily and safely bendable. Each positioning portion 2000 is spaced a predetermined distance from a top end of the corresponding cantilever 22. Each cantilever 22 forms a hook-shaped second mating member 220 at a distal end thereof. The second mating member 220 defines a second slant surface 240 and a second mating surface 242, respectively corresponding to the first slant surface 1030 and the first mating surface 1032 of a corresponding first mating member 103 of the housing 10. The second mating member 220 defines a cutout 244 in an upper outside portion thereof.

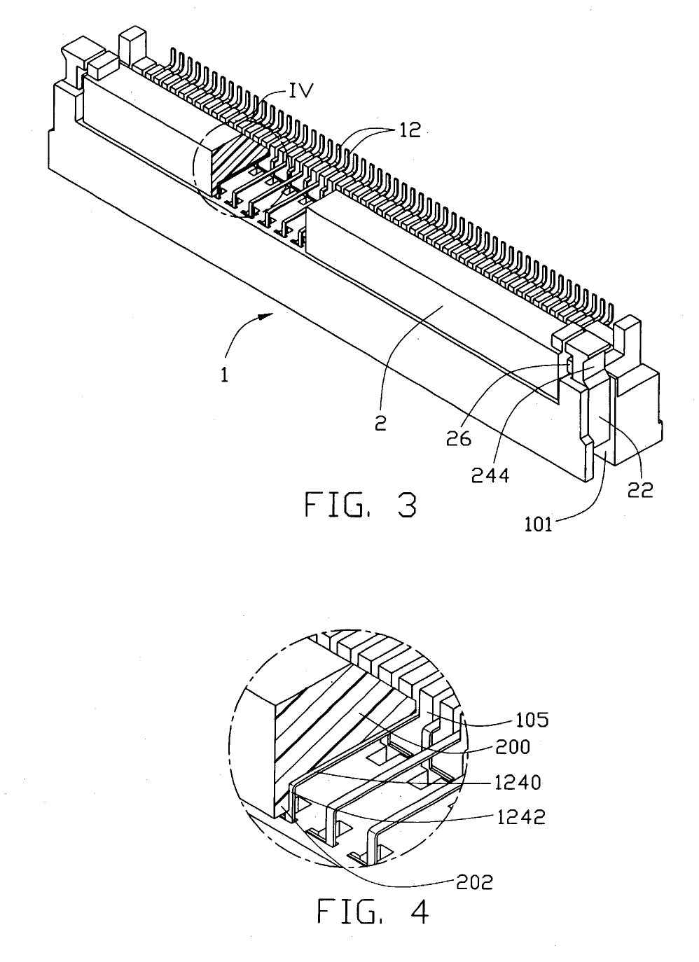

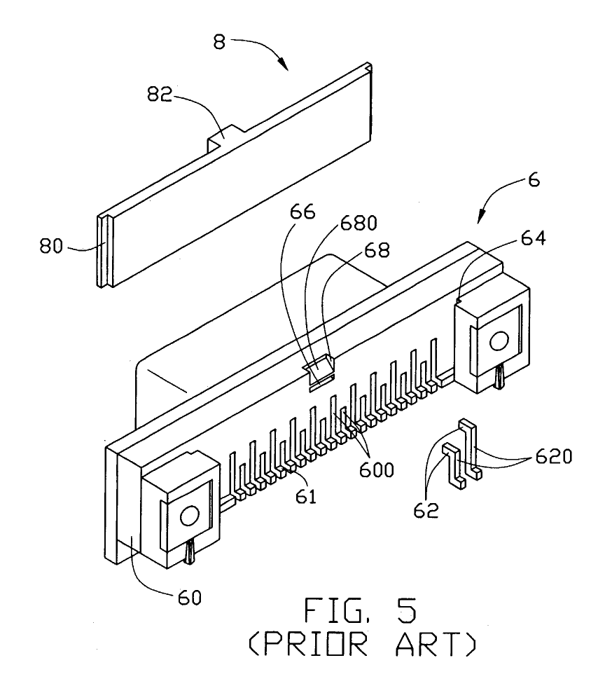

Referring to FIGS. 1, 3 and 4, in assembly of the electrical connector 1, the terminals 12 are mounted in the corresponding terminal-passages 108. The barbs 1220 of the terminals 12 interferingly engage with internal walls of the housing 10 in the terminal-passages 108. The first extending portion 1240 of each terminal 12 is received in the corresponding slot 1050 of the housing 10, in order to facilitate positioning of the terminal 12 in the housing 10.

Then the cantilevers 22 at the cutouts 244 are grasped by hand or with a clipping tool to make the cantilevers 22 rotate outwardly. A benefit of the first and second slant surfaces 1030, 240 is to decrease a required angle of rotation of the cantilevers 22. In addition, the positioning portions 2000 block the top ends of the cantilevers 22, thereby preventing excessive deformation of the connecting portions 26. As a result, the cantilevers 22 are easily and safely received in the corresponding leading grooves 101. When the first mating members 103 ride over the second mating members 220, the first and second mating surfaces 1032, 242 engage with each other. Simultaneously, a bottom face of the first stopper wall 200 abuts the supporting wall 105, thereby preventing the retention mechanism 2 from moving too far downward. Thus the retention mechanism 2 is conveniently attached to the housing 10. In this position, the first stopper wall 200 presses on the first extending portions 1240 of the terminals 12, and the second stopper wall 202 presses on the second extending portions 1242 of those terminals 12 that have their second extending portions 1242 arranged in a row distalmost from the mounting face 106. Thus, all the terminals 12 are firmly retained in the corresponding terminal-passages 108. Good mechanical and electrical stability of the connector 1 is assured.

In disassembly of the retention mechanism 2 from the housing 10, the cantilevers 22 are rotated outwardly. The first mating members 103 disengage from the second mating members 220, and the cantilevers 22 are pulled out from the grooves 101. Thus the retention mechanism 2 is conveniently detached from the housing 10.

In the above-described electrical connector 1, the retention mechanism 2 mates with the housing 10 by way of hooking engagement between the first mating members 103 and the second mating members 220. It should be understood that means of mating the retention mechanism 2 with the housing 10 may alternatively comprise other forms of mechanical engagement. Various mating means may be adopted, depending on the particular configurations of the housing 10 and the retention mechanism 2.

In addition, although the present invention has been described with reference to a particular embodiment, it is not to be construed as being limited thereto. Various alterations and modifications can be made to the embodiment without in any way departing from the scope or spirit of the present invention as defined in the appended claims.

What is claimed is:

1. An electrical connector comprising:
a dielectric housing defining a plurality of terminal-passages therein and first mating members thereon, a plurality of terminals each having a bending portion extending outside of a corresponding terminal-passage, and a retention mechanism attached to the housing, the retention mechanism comprising:
at least one elongate stopper wall;
cantilevers depending from the at least one stopper wall toward the housing; and
second mating members respectively engaging with the first mating members to retain the terminals in the corresponding terminal-passages by the at least one stopper wall pressing on the bending portions of the terminals.

2. The electrical connector of claim 1, wherein the housing defines guiding grooves at respective opposite ends thereof.

3. The electrical connector of claim 2, wherein each of the first mating members extends vertically outwardly from an inner surface of the housing at the corresponding groove.

4. The electrical connector of claim 3, wherein each of the first mating members comprises a first slant surface.

5. The electrical connector of claim 4, wherein each of the first mating members defines a first mating surface oriented at an acute angle relative to the inner surface of the housing at the corresponding groove.

6. The electrical connector of claim 5, wherein the cantilevers are disposed at respective opposite ends of the stopper wall, the second mating members are defined at distal end of the cantilevers, and the second mating members each comprises a second slant surface corresponding to the first slant surface of a respective first mating member.

7. The electrical connector of claim 6, wherein each of the cantilevers is pivotally attached to the stopper wall by a connecting portion, and the stopper wall defines a pair of positioning portions at opposite ends of a top surface thereof.

8. The electrical connector of claim 7, wherein each of the second mating members is generally hook-shaped.

9. The electrical connector of claim 8, wherein each of the cantilevers defines a cutout in an upper outside portion thereof.

10. The electrical connector of claim 9, wherein the bending portion comprises first and second extending portions that are perpendicular to each other, the first and second extending portions extending outside the corresponding terminal-passage.

11. An electrical connector comprising:
an insulative housing defining upper and lower rows of passageways extending therethrough in a front-to-back direction;
upper and lower rows of terminals received in the corresponding passageways, respectively, and extending out of a rear face of the housing in an alternative manner, each of said terminals defining a right angle tail with thereof horizontal and vertical sections perpendicular to each other;
a horizontal support wall extending rearwardly from the rear face with a plurality of slots to respectively receive the corresponding vertical sections of the tails;
a retention mechanism attached to the rear face of the housing, said retention mechanism including a top plane downwardly pressing the horizontal sections of the tails of the upper row of the terminals, and a vertical inner face forwardly abutting against the vertical sections of the tails of the upper row of terminals

12. The connector of claim 11, wherein said retention mechanism further includes a bottom plane supportably seated upon a top face of the support wall.

13. The connector of claim 11, wherein said vertical inner face further forwardly abuts against upper portions of the vertical sections of the tails of the lower rows of terminals.

14. The connector of claim 11, wherein said retention mechanism includes a manually operable cantilever hooked to the housing horizontally.

15. The connector of claim 14, wherein said cantilever is received in a corresponding groove in the housing for restricting vertical movement relative to the housing.

16. The connector of claim 14, wherein said retention mechanism is forwardly assembled to the rear face of the housing in a horizontal direction.
